(19) United States
(12) Patent Application Publication
(10) Pub. No.: US 2019/0347736 A1
(43) Pub. Date: Nov. 14, 2019

(54) Adjusted Factor-Based Performance Attribution

(71) Applicant: Axioma, Inc., New York, NY (US)

(72) Inventors: Robert A. Stubbs, Roswell, GA (US); Vishv Jeet, Marietta, GA (US)

(21) Appl. No.: 16/522,611

(22) Filed: Jul. 25, 2019

Related U.S. Application Data
(63) Continuation of application No. 14/336,123, filed on Jul. 21, 2014, now abandoned.
(60) Provisional application No. 61/869,351, filed on Aug. 23, 2013.

(51) Int. Cl. G06Q 40/06; G06Q 10/06

(52) U.S. Cl. CPC G06Q 40/06; G06Q 10/067

(57) ABSTRACT

Performance attribution results of investment portfolios are often misleading due to correlation between the factor and specific contributions. This correlation is not correctly accounted for in standard factor-based attribution thus leading to potentially erroneous results. The present invention produces an adjusted factor-based performance attribution methodology that moves a portion of the specific return that is correlated with the factor contributions into the factor portion. This methodology adjusts the contribution to a subset of factors and to the specific contributions such that the resulting factor and specific contributions have small correlation.

The present application is a continuation of U.S. application Ser. No. 14/366,123 filed Jul. 21, 2014 entitled Adjusted Factor Based Performance Attribution which is assigned to the assignee of the present application and incorporated by reference herein in its entirety, and which claims the benefit of U.S. Provisional Application Ser. No. 61/869,351 filed Aug. 23, 2013 which is incorporated by reference herein in its entirety.

### FIELD OF INVENTION

The present invention relates to methods for calculating factor-based performance attribution results for investment portfolios using factor and specific return models usually associated with factor risk models. More particularly, it relates to improved computer based systems, methods and software for calculating performance attribution results that reduce the correlation between the attributed factor and specific contributions.

Factor-based performance attribution results are often misleading due to correlation between the factor and specific contributions. Ideally, the correlation between the factor and specific correlations should be close zero. The present invention adjusts existing factor-based performance attribution methodologies to correct unintuitive results arising from correlated factor and specific contributions.

### BACKGROUND OF THE INVENTION

Factor-based performance attribution is one technique that can be used to explain the historical sources of return of a portfolio. The methodology relies on factor and specific return models to decompose and explain the return of the portfolio in terms of various separate contributions. Often, the factor and specific return models are associated with a factor risk model. The portion of the portfolio return that can be explained by the factors is called the factor contribution. The remainder of the return is called the asset-specific contribution.

If a fundamental or quantitative portfolio manager constructs his or her portfolio based on a criterion that is not well explained by the factors, then factor-based performance attribution may attribute a significant portion of the return to the asset-specific contribution.

Many portfolio managers construct their portfolios with explicit exposures to quantitative factors. These quantitative factors are often associated with the returns or risk of individual assets. These quantitative factors can be risk factors of a factor risk model. For example, many portfolios are constructed to have large exposures to factors that are perceived to drive positive returns. In addition, the aggregate exposure of a portfolio to other quantitative factors may be limited to lie within certain bounds. Factor-based performance attribution for these kinds of portfolios can show significant contributions arising from the targeted factors.

Some portfolio managers construct and use a custom risk model containing proprietary factors as the risk model factors. These proprietary factors are signals that the portfolio manager believes will either out-perform the market or will describe market performance well. Factor-based performance attribution using the factors of a custom risk model with proprietary factors decomposes performance across the proprietary signals. These results can be used to evaluate whether or not the signals thought to drive performance actually did.

In a high quality factor model, the average correlation between the model factor returns and the specific returns of each asset is close to zero. Because the average correlation is zero, it is often expected that the correlation between the factor contributions and the specific contributions of a factor-based performance attribution for a set of historical portfolios will also be close to zero. In practice, this is not always true.

### SUMMARY OF THE INVENTION

Among its several aspects, the present invention recognizes, that often, the correlation between the factor contributions and the specific contributions of a factor-based performance attribution is not always close to zero in practice.

Consider a specific attribution problem derived from a backtest of optimal allocations. Using Value, Quality, and Earnings Momentum alpha signals derived from data provided by Credit Suisse HOLT and Price Momentum alpha signal data provided by Axioma, a set of expected returns was constructed for each period in a backtest. At each time period, an optimized portfolio was constructed using the following conditions.

Consider the T time periods denoted as t₁, t₂, . . . , t_{T} and the N possible investment opportunities indexed as i=1, 2, . . . , N.

At each of the T time periods, maximize

Expected return=α^{T}w (1)

subject to six constraints:

$$\begin{matrix} Long Only \text{:} 0 \% \leq {w}_{( i )} \leq 100 \% , i = 1 , … N & ( 2 ) \\ Fully Invested \text{:} { \sum }_{i = 1}^{N} {w}_{( i )} = 100 \% & ( 3 ) \\ Active Asset Bounds \text{:} - 3 \% \leq {w}_{( i )} - {w}_{( bi )} \leq 3 \% , i = 1 , … , N & ( 4 ) \\ Active Sector Bounds \text{:} - 4 \% \leq {\sum }_{i ∈ {S}_{j}} {w}_{( i )} - {w}_{( bi )} \leq 4 \% , j = 1 , … , 10 & ( 5 ) \\ Turnover \text{:} { \sum }_{i = 1}^{N} \vert {w}_{( i )} - {w}_{( i )}^{( current )} \vert \leq 30 \% & ( 6 ) \\ Active Risk \text{:} \sqrt{{( w - {w}_{b} )}^{T} Q ( w - {w}_{b} )} \leq TE & ( 7 )\end{matrix}$$

In this formulation, the mathematical variables are defined as follows.

A universe or set of N potential investment opportunities or assets is defined. For example, the stocks comprising the Russell 1000 index represent a universe of approximately 1000 U.S. large cap stocks or N=1000. The stocks comprising the Russell 2000 index represent a universe of approximately 2000 U.S. small cap stocks or N=2000.

The N-dimensional column vector w represents the weight or fraction of the available wealth invested in each asset. The N-dimensional column vector w_{b} is used to represent a benchmark investment in the universe of investment opportunities. The indexing of each of these column vectors is the same, meaning that the i-th entry in w, denoted here as w₍ᵢ₎, and the i-th entry in w_{b}, denoted here as w_{(bi)}, give investment weights to the same investment opportunity or asset.

The investment portfolio and the benchmark portfolio are long-only and fully invested. This requires that the allocation to any individual equity is non-negative and at most 100%. This requirement is mathematically described by equation (2). The sum of the investment allocations over all the investment opportunities is 100%. This requirement is described by equation (3).

In addition to the column vectors w and w_{b}, an N-dimensional column vector of expected returns is utilized. This vector of expected returns or alphas is represented by α. In this particular example, for each time period considered, the entries in a are given by a linear combination of the three Credit Suisse HOLT data vectors Value, Quality and Earnings Momentum and Axioma's data vector for Price Momentum. Since there are T time periods in the backtest, there will be T different α's, T different benchmark allocations, w_{b}, and T different optimal portfolio allocations, w, each corresponding to a particular time period.

The objective function at each time period is the vector inner product of the expected return and the optimal portfolio allocation w, described mathematically by α^{T}w where the superscript T indicates vector or matrix transposition. The optimal portfolio allocation maximizes this inner product. This function is described by equation (1).

In addition to the long only and fully invested constraints (2) and (3), constraints were also imposed on the active weights of the portfolio, where the active weight of the i-th asset is the difference in the weight of the optimal portfolio w₍ᵢ₎ and the weight of the benchmark portfolio w_{(bi)}. For this particular problem, each active weight is constrained to be between −3% and +3%, as shown in equation (4). This constraint ensures that the optimal portfolio weights are not too different from the benchmark weights.

For this particular problem, the Global Industry Classification Standard (GICS) developed by MSCI and Standard & Poor's is used. In this standard classification scheme, assets are assigned to one of ten different sectors according to which best describes the underlying business of the equity asset. The ten sectors are Consumer Discretionary, Consumer Staples, Energy, Financials, Health Care, Industrials, Information Technology, Materials, Telecommunication Services, and Utilities. The net active weight for each of these ten sectors is defined as the sum of the difference in the optimal and benchmark weights for every asset in the sector. For this particular problem, the net active weight for each sector is constrained to be between −4% and +4%. This constraint is shown by equation (5), where the index j corresponds to each of the ten GICS sectors, denoted here as Sj. As with the constraint on active asset weights, this constraints limits aggregate differences between the optimal portfolio and the benchmark portfolio.

For this particular problem, the turnover of the portfolio, defined as the sum of the absolute value of the differences in each asset's optimal portfolio weight wᵢ and the current holdings of each asset, denoted here by w₍ᵢ₎^{(current)} is also constrained, so that the total turnover is less than 30%, as shown in equation (6).

Finally, a constraint is imposed on the active risk of the optimal portfolio. The limit used is denoted as TE (for tracking error) and is shown in equation (7). In this formula, Q denotes the N by N dimensional symmetric, positive semi-definite matrix giving the predicted covariance for each of the asset-asset pairs in the universe.

In practice, Q is given by a factor risk model, which is a convenient factorization of the full matrix Q. Of course, although this particular example employs a factor risk model to construct the portfolios, it is not necessary that a factor risk model be used to construct investment portfolios. The invention described here is applicable to all investment portfolios, not just those constructed using factor risk models.

In a factor risk model, Q is given by the matrix equation

Q=BΣB^{T}+Δ² (8)

where

Q is an N by N covariance matrix

B is an N by K matrix of factor exposures (also called factor loadings)

Σ is a K by K matrix of factor covariances

Δ² is an N by N matrix of security specific covariances; often, Δ² is taken to be a diagonal matrix of security specific variances. In other words, the off-diagonal elements of Δ² are often neglected (e.g., assumed to be vanishingly small and therefore not explicitly computed or used).

In general, the number of factors, K, is much less than the number of securities or assets, N.

The covariance and variance estimates in the matrix of factor-factor covariances, Σ, and the (possibly) diagonal matrix of security specific covariances, Δ², are estimated using a set of historical estimates of factor returns and asset specific returns.

The historical factor return for the i-th asset and the p-th historical time period is denoted as f₍ᵢ₎^{(p)}. Then

Σᵢⱼ=Covₚ(f₍ᵢ₎^{(p)},f₍ⱼ₎^{(p)}) (9)

where the notation Covₚ( ) indicates computing an estimate of the covariance over the time history of the variables. The historical specific return for the i-th asset and the p-th historical time period is denoted as ε₍ᵢ₎^{(p)}. For the case of a diagonal specific covariance matrix,

Δᵢᵢ²=Varₚ(ε₍ᵢ₎^{(p)}) (10)

where the notation Varₚ( ) indicates computing an estimate of the variance over the time history of the variable. Both the covariance and variance computations may utilize techniques to improve the estimates. For example, it is common to use exponential weighting when computing the covariance and variance. This weighting is described in R. Litterman, Modern Investment Management: An Equilibrium Approach, John Wiley and Sons, Inc., Hoboken, N.J., 2003, which is incorporated by reference herein in its entirety. It is also described in R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein in its entirety. U.S. Patent Application Publication No. 2004/0078319 A1 by Madhavan et al. also describes aspects of factor risk model estimation and is incorporated by reference herein in its entirety.

The covariance and variance estimates may also incorporate corrections to account for the different times at which assets are traded across the globe. For example, U.S. Pat. No. 8,533,107 describes a returns-timing correction for factor and specific returns and is incorporated by reference herein in its entirety.

The covariance and variance estimates may also incorporate corrections to make the estimates more responsive and accurate. For example, U.S. Pat. No. 8,700,516 describes a dynamic volatility correction for computing covariances and variances, and is incorporated by reference herein in its entirety.

Returning to the example calculation, the investment universe and benchmark is the Russell Developed Index. This is an index of over 5000 equities drawn from economically developed countries around the world. The index includes equities from countries such as the United States, Japan, the United Kingdom, Canada, and Switzerland. The weights in the benchmark are proportional to the market capitalization of each equity.

The portfolio is rebalanced monthly from February 2000 to January 2013, which comprises 156 monthly rebalances. At each of the 156 monthly rebalancing times, the optimal holdings are computed using two different factor risk models. In the first instance, a standard, commercially available, fundamental factor equity risk model, the Axioma, World-Wide, Fundamental Factor, Medium Horizon, Equity Risk Model, denoted as WW, was used. This factor risk model is sold commercially by Axioma, Inc.

In the second instance of the backtest, optimal portfolios were determined using a custom risk model, denoted here as CRM. The CRM has the same Market, Country, Industry, and Currency factors as WW. However, the set of style factors is different. FIG. 1 shows table 202 comparing the style factors used in the two risk models. WW utilizes nine style factors. These are Exchange Rate Sensitivity, Growth, Leverage, Liquidity, Medium-Term Momentum, Short-Term Momentum, Size, Value, and Volatility. In the Custom Risk Model, WW's Growth, Leverage, and Value factors are replaced with the Credit Suisse HOLT Growth, Leverage, and Value factors, denoted CSH_Growth, CSH_Leverage, and CSH_Value. WW's Short-term Momentum style factor is omitted in the CRM. In addition, the CRM includes two additional style factors derived from Credit Suisse HOLT Momentum and Quality factors, denoted as CSH_Momentum, and CSH_Quality. As illustrated in table 202, WW's standard, commercially available factor risk model utilizes nine style factors while the CRM utilizes ten style factors.

For each of the two risk model instances, WW and CRM, a set of backtests computing optimal portfolios were computed for nine different tracking errors (TE's) evenly spaced between a tracking error of 1.5% and 5.0%. In other words, in terms of Axioma's backtest product, a frontier backtest was performed for tracking errors of TE=1.50%, 1.94%, 2.38%, 2.81%, 3.25%, 3.69%, 4.13%, 4.56%, and 5.00%. For each risk model instance and each tracking error constraint, the set of optimal portfolios at each monthly rebalance was used to determine performance statistics for each tracking error and risk model. Of primary interest here is the realized annual return and the realized annual volatility of the active returns. When plotted on a graph with realized volatility on the horizontal axis and realized return on the vertical axis, the result is a realized efficient frontier. This graph indicates the relative risk/return tradeoff of each risk model instance. Note that even though the predicted tracking error is set to one of the nine values listed above, the realized tracking error for any backtest may be slightly less than or greater than the proscribed constraint depending on the realized portfolio returns.

FIG. 2 shows the realized efficient frontier for the two risk model backtests. The efficient frontier 204 obtained using the CRM is shown with the thick, solid, black line. The efficient frontier 206 obtained using the WW risk model is shown by the black, thin, dashed line. Using CRM improved the realized performance of the backtest. This improvement is seen by comparing efficient frontiers 204 and 206. For any level of realized risk, the realized return for the CRM is as high or higher than that of WW. For this example, investment professionals would prefer to use the CRM when constructing portfolios since it is more likely to give improved realized performance for the portfolios constructed.

Performance attribution is a tool that explains the realized performance of a set of historical portfolios using a set of explicatory factors. The factors often are those employed in a factor risk model. This breakdown identifies the sources of return, often termed contributions, that, when added together, describe the portfolio performance as a whole. Performance attribution can be performed on either the returns of the optimal portfolio, w, or the returns of the active portfolio, w−w_{b}.

For an active portfolio, at each time period p,

$$\begin{matrix} Portfolio Contribution = {R}^{( p )} = {\sum }_{i = 1}^{N} ( {w}_{( i )}^{( p )} - {w}_{( bi )}^{( p )} ) {r}_{i}^{( p )} & ( 11 ) \\ Portfolio Factor Contribution = {FR}^{( p )} = {\sum }_{i = 1}^{N} {\sum }_{j = 1}^{K} ( {w}_{( i )}^{( p )} - {w}_{( bi )}^{( p )} ) {B}_{( ij )}^{( p )} {f}_{( j )}^{( p )} & ( 12 ) \\ Portfolio Specific Contribution = {SR}^{( p )} = {R}^{( p )} - {FR}^{( p )} & ( 13 )\end{matrix}$$

are computed where r₍ᵢ₎^{(p)} is the asset return of the i-th asset at time p. In traditional performance attribution, these period contributions are compounded and linked together so that their aggregate contribution sum to the total active return of the portfolio. See Litterman for details of several methods for compounding and linking contributions including the methodology proposed by the Frank Russell Company and the methodology proposed by Mirabelli.

For example, in the method proposed by the Frank Russell Company, the portfolio return and one-period sources of return are computed in terms of percent returns. Then, each one-period percent return is multiplied by the ratio of the portfolio log-return to the percent return for that period. Then, the resulting returns are converted a second time back into percent returns by multiplying by the ratio of the full period percent return to the full period log return. This achieves the important attribution characteristic of having multi-period sources of return that are additive. Of course, these transformations perturb the realized risk of the contributions since the original period contributions are perturbed. In general, the modifications derived from linking for both contributions and risk contributions are small.

By restricting the values of j in equation (12) to a subset of the K factors, the contribution of a factor or group of factors towards the overall performance can be computed. For example, the style contribution is computed by including only those j's corresponding to style factors.

If a portfolio has been constructed to maximize its exposure to an alpha signal, then that strong exposure to alpha translates into a strong exposure to the risk model factors that best describe the alpha signal. Ideally, one would see large positive contributions from those factors that describe the alpha signal well and relatively smaller contributions from the other factors and the specific return contribution.

Performance attribution was run on the two sets of backtest portfolios that had realized active risks of approximately 4%. The results are summarized in table 208 of FIG. 3. Three sets of results are reported. In the WW/WW case, the results are reported for the backtest portfolios that were optimized using WW, the standard risk model, and then attribution was performed using the same model (WW). In the WW/CRM column, the backtest optimized portfolios obtained using WW are reported, but the attribution is done using the CRM. Finally, in the CRM/CRM column, both the optimization and attribution are done using the CRM.

As seen in FIG. 3, the aggregate active contribution for the portfolios optimized with WW is 3.26%. For the portfolios optimized with CRM, it is 3.47%. Therefore, since both have approximately the same realized tracking error (active risk), the CRM performance is better than the WW performance.

The aggregate factor contribution for the CRM/CRM case is substantially larger than the WW/WW case. The aggregate factor contribution for the CRM/CRM case is 10.68% whereas it is only 2.68% for the WW/WW case. Note that the difference between these two attributions is much larger than the aggregate active contributions. Since the sum of the factor contribution and the specific contribution must equal the active contribution, the CRM/CRM specific contribution is large and negative. In the standard WW/WW case, it is small and positive.

It is often expected that the factor contribution will be large and positive.

If the optimal portfolios have substantial exposure to the alpha signal, and the alpha signal is well described by a subset of the factors used for the attribution, and the alpha signal drove positive returns, then a portfolio manager would expect to see large, positive factor contribution, as occurs for all cases in FIG. 3. However, when the specific contribution is large and negative, as it is in both CRM attributions, it effectively cancels out the desired large, positive, factor contribution. The apparent negative correlation between the factor contribution and the specific contribution shown in the CRM attributions in FIG. 3 are difficult to interpret and potentially misleading.

The WW/CRM case is presented to demonstrate that the effect shown is a result of the factors used for attribution and not the effect of the risk model used for optimization, if any risk model is used at all for portfolio construction. The portfolios analyzed in WW/WW and WW/CRM are identical. However, the size and sign of the factor and specific contributions for WW/CRM are quite similar to the CRM/CRM case.

In FIG. 4, the cumulative factor contribution 210 and the cumulative asset-specific contributions 212 for the CRM/CRM attribution from January 2000 until December 2012 are both plotted. It is seen that the cumulative factor and asset-specific contributions are moving in opposite directions suggesting that the contributions are negatively correlated. In fact, the correlation between the monthly factor and asset-specific contributions over the entire backtest is −0.308. For this particular portfolio, the factor and asset-specific contributions are negatively correlated. This negative correlation is the problem with existing performance attribution methodologies that the present invention corrects.

This problem is not unique to this particular case. The problem arises to some extent within nearly every portfolio. While the example presented here used a custom risk model, the problem may arise in all sets of attribution factors.

When the factors used for attribution are the factors of a factor risk model, factor and asset-specific portfolio returns with non-zero correlations violate one of the assumptions of a factor risk model and thus introduce error into both risk estimation and factor-based performance attribution. The error exists with custom risk models and with standard factor risk models such as fundamental factor, statistical factor, macroeconomic factor and dense risk model. It may be found in all kinds risk models.

The present invention adjusts the factor-based performance attribution methodology to account for the correlation between the factor and asset-specific contributions that were computed using any attribution methodology. In essence, the proposed adjusted attribution is a combination of factor-based attribution and style analysis. Here, the style factor returns, as opposed to Industry or Country factor returns, are generally the most significant factor returns. Because all the factor returns are already present in the attribution, the asset-specific contributions that can be explained by the factors are added back into contributions to the factors rather than accounting for the styles separately.

The present invention also recognizes that current portfolio performance attribution methodologies do not adjust for non-zero realized correlation between the attributed factor contributions and specific contributions.

One goal of the present invention, then, is to describe a methodology that will automatically adjust factor and specific contributions in a performance attribution so that their realized correlation is closer to zero.

Another goal is to describe an improved method for identifying the contributing factors in a performance attribution.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a table listing the style factors used in two risk models, a standard and a custom factor risk model;

FIG. 2 graphically illustrates a realized efficient frontier for two backtests using different factor risk models;

FIG. 3 illustrates a list of factor and specific contributions for different combinations of portfolios derived from optimization using different factor risk models and performance attribution using different sets of factors;

FIG. 4 illustrates the cumulative factor contributions and cumulative asset-specific contributions over time for a particular example;

FIG. 5 shows a computer based system which may be suitably utilized to implement the present invention;

FIG. 6 shows regression statistics for the calculation of a set of betas;

FIG. 7 shows the betas for a set of factors and their statistics of significance as determined by a time-series regression;

FIG. 8 shows a table of adjusted performance attribution contributions for a first numerical example;

FIG. 9 shows a table of adjusted performance attribution contributions for a second numerical example;

FIG. 10 shows a table of adjusted performance attribution risk decompositions for the second numerical example;

FIG. 11 illustrates benchmark weights for a simple, four asset example;

FIG. 12 illustrates asset returns for a simple, four asset, five time period example;

FIG. 13 illustrates the factor exposures for a simple, four asset, five time period example;

FIG. 14 illustrates the factor returns and specific returns for the factor exposures employed in a simple, four asset, five time period example;

FIG. 15 illustrates the time series correlation of factor returns and specific returns in a simple, four asset, five time period example;

FIG. 16 illustrates the factor-factor covariance matrix and vector of specific risks for the factor exposures employed in a simple, four asset, five time period example;

FIG. 17 illustrates the factor mimicking portfolios for the S1 and I1 factors of the factor risk model employed in a simple, four asset, five time period example;

FIG. 18 illustrates the asset returns, the factor returns, and the returns of the benchmark, and the S1 and I1 factor mimicking portfolios for a simple, four asset, five time period example;

FIG. 19 illustrates a first exemplary portfolio for a simple, four asset, five time period example;

FIG. 20 illustrates the portfolio returns, factor and specific contributions, and the correlation of the factor and specific contributions for the first exemplary portfolio in a simple, four asset, five time period example;

FIG. 21 illustrates the results of two possible time series regression models modelling the specific contributions as linear functions of select factor contributions;

FIG. 22 illustrates adjusted factor and specific contributions, and the adjusted correlation of the adjusted factor and specific contributions for the first exemplary portfolio in a simple, four asset, five time period example;

FIG. 23 illustrates a second exemplary portfolio for a simple, four asset, five time period example;

FIG. 24 illustrates the portfolio returns, factor and specific contributions, and the correlation of the factor and specific contributions for the second exemplary portfolio in a simple, four asset, five time period example;

FIG. 25 illustrates the results of two possible time series regression models modelling the specific contributions as linear functions of select factor contributions;

FIG. 26 illustrates adjusted factor and specific contributions, and the adjusted correlation of the adjusted factor and specific contributions for the second exemplary portfolio in a simple, four asset, five time period example;

FIG. 27 illustrates an adjusted factor-factor covariance matrix and vector of specific risks for the second exemplary portfolio in a simple, four asset, five time period example; and

FIG. 28 illustrates a flow chart of the steps of a process in accordance with an embodiment of the present invention.

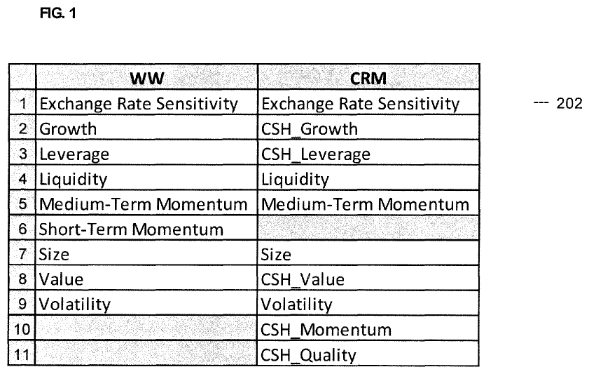

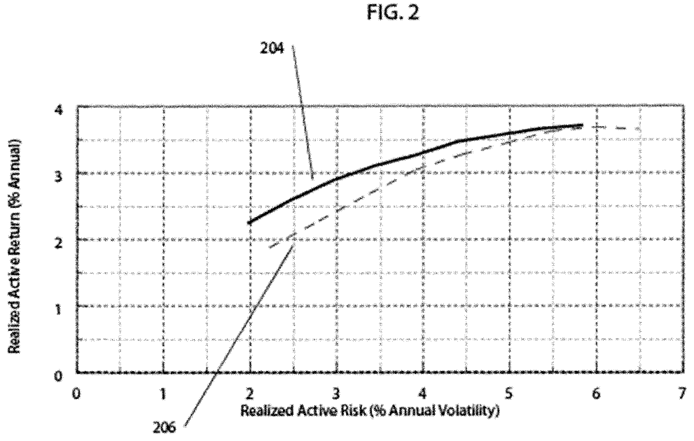

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

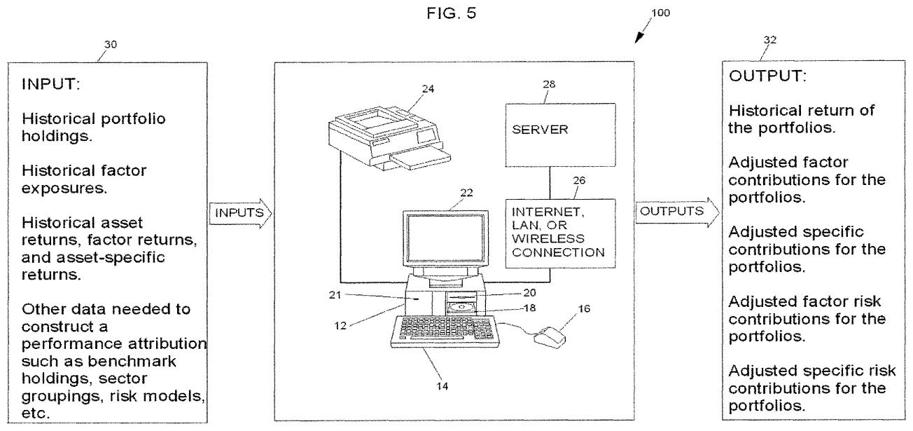

FIG. 5 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed. As shown in FIG. 5 and described in further detail below, the system 100 includes software that is run by the central processing unit of the computer or mobile device 12. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 may also have a USB connection 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running in Windows 7. Another embodiment of the invention has been designed to run on a Linux-based server system. The present invention may be coded in a suitable programming language or programming environment such as Java, C++, Excel, R, Matlab, Python, etc.

According to one aspect of the invention, it is contemplated that the computer or mobile device 12 will be operated by a user in an office, business, trading floor, classroom, or home setting.

As illustrated in FIG. 5, and as described in greater detail below, the inputs 30 may suitably include historical portfolio holdings, historical factor exposures, historical asset returns, factor returns, and asset-specific returns as well as other data needed to construct the performance attribution such as benchmark holdings, sector grouping, risk models, and the like. Factor risk models may suitably include fundamental factor risk models, statistical factor risk models, and macroeconomic factor risk models. Dense risk model may also be used.

As further illustrated in FIG. 5, and as described in greater detail below, the system outputs 32 may suitably include the historical return of the portfolios, the adjusted factor contributions for the portfolios, the adjusted specific contributions for the portfolios, the adjusted factor risk contributions for the portfolios, and the adjusted specific risk contributions for the portfolios.

The output information may appear on a display screen of the monitor 22 or may also be printed out at the printer 24. The output information may also be electronically sent to an intermediary for interpretation. For example, the performance attribution results for many portfolios can be aggregated for multiple portfolio reporting. Other devices and techniques may be used to provide outputs, as desired.

With this background in mind, we turn to a detailed discussion of the invention and its context. Since factor risk models provide the most common set of factor exposures used for factor attribution, the invention is described in that context. It will be clear to those skilled in the art that only factor exposures are needed and the invention can be utilized using factor exposures without a factor risk model. Factor risk models are constructed based on the assumption that asset returns can be modelled with a linear factor model at any time p as follows:

r^{(p)}=B^{(p)}f^{(p)}+ε^{(p)} (14)

Corrₚ(f₍ᵢ₎^{(p)},ε₍ₖ₎^{(p)})=0 for all j=1, . . . ,K and k=1, . . . ,N (15)

Corrₚ(ε₍ₖ₎^{(p)},ε₍ₙ₎^{(p)})=0 for k≠n, k=1, . . . ,N and n=1, . . . ,N (16)

where Corrₚ( ) indicates the correlation of the two variables over different times p. The assumptions are that every asset's specific return is uncorrelated to each of the factor returns and that the specific returns of every asset are uncorrelated to other asset specific returns.

The following matrices of returns can be constructed over the T time periods t₁, t₂, . . . , t_{T}: a matrix of asset returns

R=[r^{(t}^{₁}⁾r^{(t}^{₂}⁾ . . . r^{(t}^{_{T}}⁾] (17)

a matrix of factor returns

F=[f^{(t}^{₁}⁾f^{(t}^{₂}⁾ . . . f^{(t}^{_{T}}⁾] (18)

and a matrix of specific returns

e=[ε^{(t}^{₁}⁾ε^{(t}^{₂}⁾ . . . ε^{(t}^{_{T}}⁾] (19)

Then, if the mean returns are sufficiently small, an asset-asset covariance matrix Q is given by

$$Q = {Var}_{p} ( R ) = {E}_{p} [ {RR}^{T} ] = {E}_{p} [ ( {B}^{( p )} {f}^{( p )} + {ɛ}^{( p )} ) {( {B}^{( p )} {f}^{( p )} + {ɛ}^{( p )} )}^{T} ] = {BE}_{p} [ {FF}^{T} ] {B}^{T} + {E}_{p} [ {ee}^{T} ] + {E}_{p} [ {BFe}^{T} + {eF}^{T} {B}^{T} ] = B Σ {B}^{T} + {Δ}^{2} + {E}_{p} [ {BFe}^{T} + {eF}^{T} {B}^{T} ] \qquad ( 20 )$$

Comparing this computation (20) to the standard risk model formulation shown in equation (8), we see that equation (15) ensures that the last term in (20), Eₚ[BFe^{T}+eF^{T}B^{T}] is zero, while equation (16) ensures that Δ² is diagonal. These are standard assumptions used when constructing factor risk models.

In assessing the quality of a factor risk model, one should assess how accurate the assumptions described by equations (15) and (16) are.

Let the factor returns in f^{(p)} be determined by a cross-sectional weighted least-squares regression with diagonal weighting matrix W at each time p. Then the factor returns f^{(p)} are given by

f^{(p)}=(B^{(p)T}W B^{(p)})⁻¹B^{(p)T}W r^{(p)} (21)

Using this result in equation (14), we obtain

$${r}^{( p )} = {B}^{( p )} {f}^{( p )} + {ɛ}^{( p )} = {{B}^{( p )} ( {B}^{( p ) T} {WB}^{( p )} )}^{- 1} {B}^{( p ) T} {Wr}^{( p )} + ( I - {{B}^{( p )} ( {B}^{( p ) T} {WB}^{( p )} )}^{- 1} {B}^{( p ) T} W ) {r}^{( p )} \qquad ( 22 )$$

where I is the identity matrix.

Now, consider the attribution of a portfolio h, which may be a vector of portfolio weights or active weights. The return of the portfolio at time period p can be decomposed as follows:

$$\begin{matrix}{h}^{( p ) T} {r}^{( p )} = {\sum }_{j = 1}^{M} {FC}_{( j )}^{( p )} + {SC}^{( p )} & ( 23 ) \\ {FC}_{( j )}^{( p )} = ( {\sum }_{i = 1}^{N} {h}_{( i )}^{( p )} {B}_{( ij )}^{( p )} ) ( {FMP}_{( j )}^{( p ) T} {r}^{( p )} ) & ( 24 ) \\ {FMP}_{( j )}^{( p )} = {( {( {B}^{( p ) T} {WB}^{( p )} )}^{- 1} {B}^{( p ) T} W )}^{T} {\hat{e}}_{( j )} & ( 25 ) \\ {SC}^{( p )} = {h}^{( p ) T} {r}^{( p )} - {\sum }_{j = 1}^{M} {FC}_{j}^{( p )} & ( 26 )\end{matrix}$$

where h^{(p)T}r^{(p)} is the return or contribution of the portfolio h, FC₍ⱼ₎^{(p)} is the factor contribution of the j-th factor, ê₍ⱼ₎ is a column vector with zeros in all entries except the j-th entry which is one, SC^{(p)} is the asset-specific contribution, and FMP₍ⱼ₎^{(p)} is the j-th factor-mimicking portfolio. See Litterman Chapter 20 for a detailed discussion of factor-mimicking portfolios. By construction, the j-th factor mimicking portfolio has two important properties. First, the j-th factor-mimicking portfolios is defined as a portfolio that has a unit exposure to the j-th factor and vanishing exposure to all other factors in the exposure matrix B^{(p)}. Second, as illustrated here, the return of the j-th factor mimicking portfolio is equal to the j-th factor return. This result can be shown to be true by comparing equation (21) and equation (25). This identity gives

FMP₍ⱼ₎^{(p)T}r^{(p)}=f₍ⱼ₎^{(p)} (27)

As previously noted, these results hold for any set of factor exposures, which may or may not be used in fundamental, statistical, or macroeconomic factor risk models.

The factor contribution of return of the portfolio is the result of the factor exposures or loadings of the portfolio being multiplied by the returns of a set of factor-mimicking portfolios (FMPs). The asset-specific contribution corresponds to the return that cannot be explained by the factors. In other words, the asset-specific contribution of return in a given period is the total portfolio return of the portfolio during the period less the portfolio of the return attributed to the factors.

In the case where the portfolio h is exactly represented by a linear sum of factor-mimicking portfolios, then

$$\begin{matrix}{h}^{( p )} = {\sum }_{j = 1}^{M} {c}_{( j )} {FMP}_{( j )}^{( p )} & ( 28 ) \\ {h}^{( p ) T} {r}^{( p )} = {\sum }_{j = 1}^{M} {c}_{( j )} {f}_{( j )}^{( p )} & ( 29 )\end{matrix}$$

and the asset-specific contribution SC^{(p)} is identically zero, where co) are the coefficients of the linear representation of the portfolio in terms of factor-mimicking portfolios In this case, there can be no non-zero correlation between the factor contributions and the asset-specific contributions since the latter are zero.

Now consider the case where portfolio h is only partially represented by a linear sum of factor-mimicking portfolios. For concreteness, define a new diagonal matrix of weights \tilde{W}≠W and a new set of alternative factor-mimicking portfolios

F\tilde{M}P₍ⱼ₎^{(p)T}=((B^{(p)T}\tilde{W}B^{(p)})⁻¹B^{(p)T}\tilde{W})^{T}ê₍ⱼ₎ (30)

And let the portfolio h be exactly represented by a linear sum of these alternative factor-mimicking portfolios:

$$\begin{matrix} {h}^{( p )} = {\sum }_{j = 1}^{M} {\tilde{c}}_{( j )} F \tilde{M} {P}_{( j )}^{( p )} & ( 31 ) \\ {h}^{( p ) T} {r}^{( p )} = {\sum }_{j = 1}^{M} {\tilde{c}}_{( j )} ( F \tilde{M} {P}_{( j )}^{( p ) T} {r}^{( p )} ) = {\sum }_{j = 1}^{M} {\tilde{c}}_{( j )} ( {f}_{( j )}^{( p )} + ( {\tilde{f}}_{( j )}^{( p )} - {f}_{( j )}^{( p )} ) ) & ( 32 )\end{matrix}$$

In this instance, the asset-specific contribution for h will be

$${SC}^{( p )} = {\sum }_{j = 1}^{M} {\tilde{c}}_{( j )} ( {\tilde{f}}_{( j )}^{( p )} - {f}_{( j )}^{( p )} ) \qquad ( 33 )$$

The correlation between the aggregate factor contribution and the asset specific contribution will be

$${Corr}_{p} ( {\sum }_{j = 1}^{M} {FC}_{( j )}^{( p )} , {SC}^{( p )} ) = {Corr}_{p} ( {\sum }_{j = 1}^{M} {\tilde{c}}_{( j )} {f}_{( j )}^{( p )} , {\sum }_{j = 1}^{M} {\tilde{c}}_{( j )} ( {\tilde{f}}_{( j )}^{( p )} - {f}_{( j )}^{( p )} ) ) \qquad ( 34 )$$

It is easy to construct cases where this correlation is notably non-zero. Perhaps the simplest case is where the original and modified factor returns are multiples of each other. For example, if the modified factor returns are exactly half the original factor returns, \tilde{f}₍ⱼ₎^{(p)}=f₍ⱼ₎^{(p)}/2, then the correlation is minus one, and the factor and specific contributions are perfectly negatively correlated.

In the example given previously, the realized correlation between the factor and specific contributions was −0.308. This is a large, negative correlation. A better attribution decomposition between factor and specific contributions should produce a realized correlation closer to zero.

In the present invention, rather than take the factor contributions and specific contributions of a portfolio as fixed, a modified version is sought that is more likely to yield a vanishing correlation between the specific and factor contributions. First, the time series of factor and specific contributions is computed, and then, as a second step, the portfolio specific, time-series model is estimated

$${SC}^{( p )} = {\sum }_{j = 1}^{M} {β}_{( j )}^{( p )} {FC}_{( j )}^{( p )} + {u}^{( p )} \qquad ( 35 )$$

That is, a model of the original specific contributions as a function of the original factor contributions and a remainder term, u^{(p)} is produced. The constants to be fit are the betas, β₍ⱼ₎^{(p)}. On the one hand, if the original factor and specific contributions have little correlation, these correction terms are likely to be small. If, on the other hand, the original factor and specific contributions have a meaningful correlation, these correction terms will model that correlation. The M factors used in this representation may be a subset of all the factors available. Any group of factors may be used.

There are a number of important considerations to be considered when estimating the model described in equation (35). First, it is important that the number of parameters to be fit (the betas, β₍ⱼ₎^{(p)}) be less than the number of data points to fit. The number of original asset specific contributions, SC^{(p)}, will depend on the particular attribution problem. If, for example, there are monthly historical portfolios over three years, then there will be 36 monthly SC^{(p)}. If there are only 36 independent asset specific contributions available, then the model should have no more than 36 betas. However, the number of factor contributions, K, may be much greater than that. For instance, Axioma's Fundamental Factor, Medium Horizon, US Equity risk model has ten style factors and 68 GICS industries. Hence, there are a total of 78 different factors and corresponding factor contributions. Axioma's Fundamental Factor, Medium Horizon Global Equity risk model has more than 150 factors since, in addition to style and industry factors, this model includes country and currency factors. If the betas, β₍ⱼ₎^{(p)}, are allowed to vary in time, the number of betas is even larger.

In one aspect of the present invention, a reduced set of factors is employed in the model (35) where only those betas that are statistically significant are included in the adjustment of returns. All other betas will be set to zero. Further, it is assumed that the betas are the same at all time periods, although that restriction could easily be modified if, for example, the historical portfolios could easily be separated into distinct time periods.

In this context, significance is defined based on having both a statistically significant beta and a large product of beta and factor return thus having a large contribution. First, in order for a factor to have any real impact on the adjusted attribution, the exposure to the factor should be relatively large. If the factors that are likely to have large exposures are considered, it is likely only those factors that are being intentionally bet upon such as alpha factors and these should have large exposures through time. For a typical portfolio where attribution is performed on the active holdings, it is likely the style factors will be selected (or a subset thereof) as the initial list of candidate factors. The betas associated with all other factors will be set to zero (e.g., not included in the model).

Having selected an initial subset of factors such as the style factors, a staged regression can be run where the first regression produces significance statistics for (35) over the initial candidate set of factors. Next, the most insignificant factors are omitted in a second regression to create a reduced set of factors and the time-series regression (35) is run using this reduced set of factors. This process is repeated until the only factors remaining are highly statistically significant.

As those skilled in the art will recognize, there are numerous, well-established procedures for selecting a subset of factors to use in a quantitative model. The book “Practical Regression and Anova using R” by Julian J. Faraway, July 2002, which is available at http://www.biostat.jhsph.edu/˜iruczins/teaching/jf/faraway.html, suggests various standard methods in Chapter 10, “Variable Selection” incorporated by reference herein in its entirety. These methods include Backward Elimination, Forward Selection, and Stepwise Regression. “Branch-and-Bound” methods are also described that allow factors to efficiently and repeatedly enter and leave the set of selected factors.

Having determined a small set of non-zero, statistically significant betas that model equation (35) well, the adjusted the factor and asset-specific contributions are computed. The j-th, adjusted factor contributions are defined as

$${{FR}^{′}}_{( j )}^{( p )} = {\sum }_{i = 1}^{N} ( 1 + {β}_{( j )}^{( p )} ) ( {w}_{( i )}^{( p )} - {w}_{( bi )}^{( p )} ) {B}_{( ij )}^{( p )} {f}_{( j )}^{( p )} \qquad ( 36 )$$

The net adjusted specific contribution is given by

$${SR}^{′ ( p )} = {R}^{( p )} - {\sum }_{j = 1}^{M} {FR}^{′ ( p )} \qquad ( 37 )$$

The realized risk breakdown will also change. Because most performance attribution methodologies report realized risk contributions rather than predicted risk contributions, risk attribution using the present invention does not require a risk model. More of the realized risk will be attributable to factors and less to asset-specific bets. In the simple case in which the betas are constant across the entire time interval, the factor-factor covariance elements will be altered according to

Σ′₍ⱼₙ₎=(1+β₍ⱼ₎)(1+β₍ₙ₎)Σ₍ⱼₙ₎ (38)

while the asset specific risk elements will be

Δ′₍ᵢᵢ₎²=Varₚ(u₍ᵢ₎^{(p)}) (39)

If the betas are allowed to vary over time, then the adjusted factor risk model elements may be suitably constructed using the adjusted factor and specific returns. These steps may incorporate various methods for improving the estimate of factor covariance and specific risk such as employing the returns timing approaches of U.S. Pat. Nos. 8,533,107 and 8,700,516.

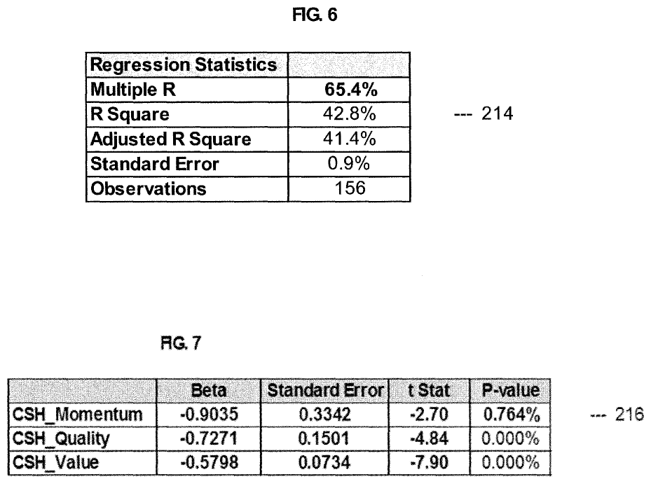

Below, the invention is illustrated with a set of numerical examples. First, consider the initial example using a CRM described herein. Initially, when betas are computed for all ten style factors in the CRM, several of those proved to be not significant. After the initial regression statistics were computed, the set of non-zero betas was reduced to a final list of three statistically significant factors: CSH_Momentum, CSH_Quality, and CSH_Value. The regression statistics for the final time series regression are summarized in table 214 shown in FIG. 6 and table 216 in FIG. 7. This particular time series utilized 156 historical portfolios. The adjusted R-squared value for the regression with three non-zero betas was 41.4%, meaning that the model explained 41.4% of the total variance in the 156 original asset specific contributions. The beta values obtained in the regression were −0.9035, −0.7271, and −0.5798 for CSH_Momentum, CSH_Quality, and CSH_Value, respectively. Each of these have large, negative T statistics (t Stat), with P-values well below the 1% significance level.

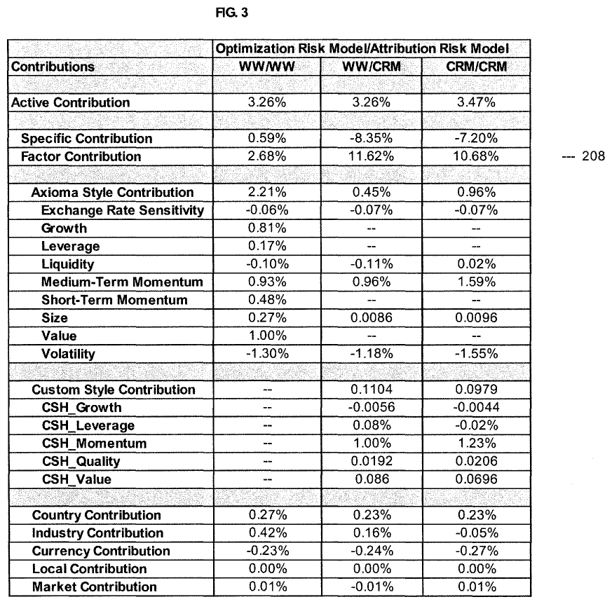

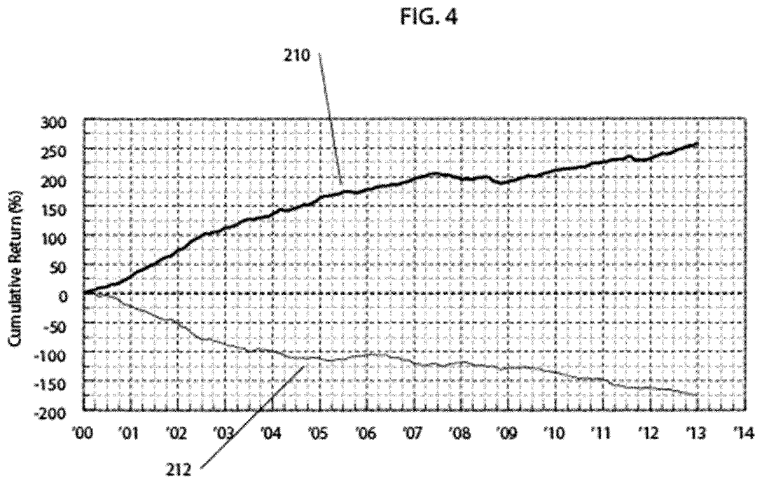

The values reported in FIGS. 6 and 7 are the non-zero betas obtained for the CRM/CRM attribution results shown in FIG. 3. Table 218 in FIG. 8 reports adjusted attribution results for all three attributions results shown in FIG. 3: WW/WW, WW/CRM, and CRM/CRM. The final, non-zero betas are different in each of these cases, although they are computed using the same methodology. Comparing table 218 to table 208, for the CRM/CRM case, the adjusted factor contribution decreases from 10.68% to 4.03% and the adjusted asset-specific contribution increased from −7.20% to −0.55%. The correlation between the adjusted factor and asset-specific contributions changed from −0.308 to 0.030. This latter value, 0.030, is much closer to zero than the original correlation.

Consider a second numerical attribution example using expected returns from a portfolio manager using a standard U.S. equity, fundamental factor risk model to define the factor exposures. The portfolio construction strategy for this example is long-short and dollar-neutral. The strategy performs well. For example, it produces positive cumulative returns.

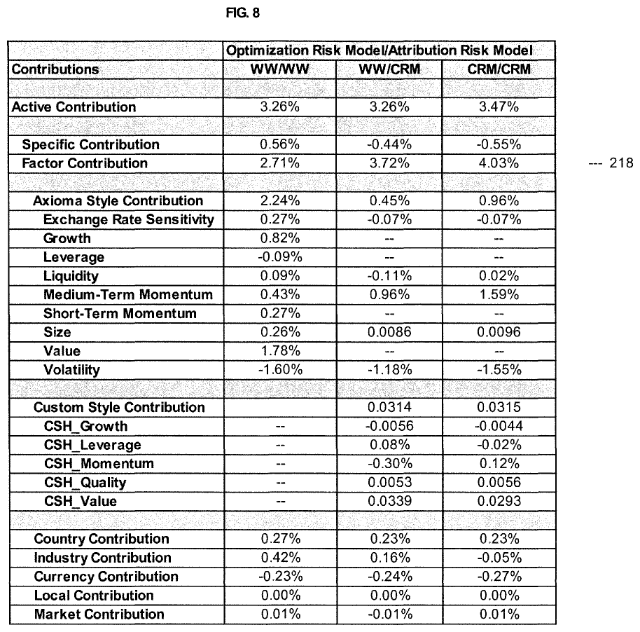

Table 220 in FIG. 9 compares a traditional attribution to an adjusted attribution for this particular set of historical portfolios. The percent of realized variance attributable to factors jumps from about 8% in the traditional attribution to more than 48% in the adjusted attribution. The return attributable to factors jumps from 1.30% in the traditional attribution to 5.73% in the adjusted attribution.

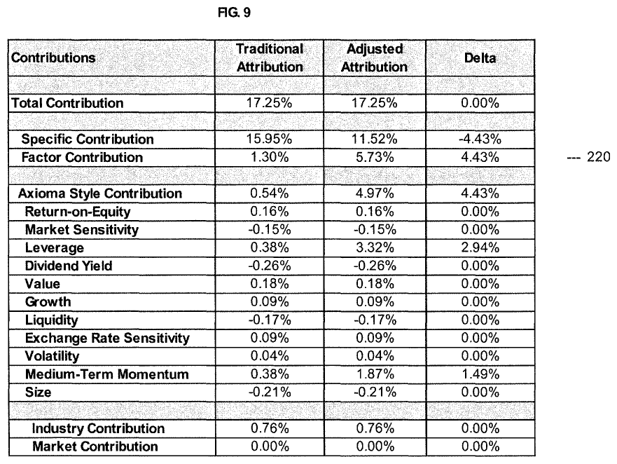

Table 222 in FIG. 10 shows the traditional risk decomposition for these portfolios compared to the adjusted risk decomposition. In the traditional risk decomposition, most of the risk is attributable to specific risk and the factor risk accounts for only a small portion. However, in this example, the traditional factor contribution and the specific contributions are positively correlated, with a correlation coefficient of 0.477. After applying adjusted attribution, the factor risk is now of approximately the same size as specific risk, and the correlation of adjusted factor and specific contributions has been reduced to −0.109.

A simple, detailed, numerically worked out example is now presented to illustrate aspects of the invention. Consider a universe of four assets identified as E1, E2, E3, and E4, and five monthly time periods, denoted here as Jan, Feb, Mar, Apr, and May. Hence N=4 and T=5.

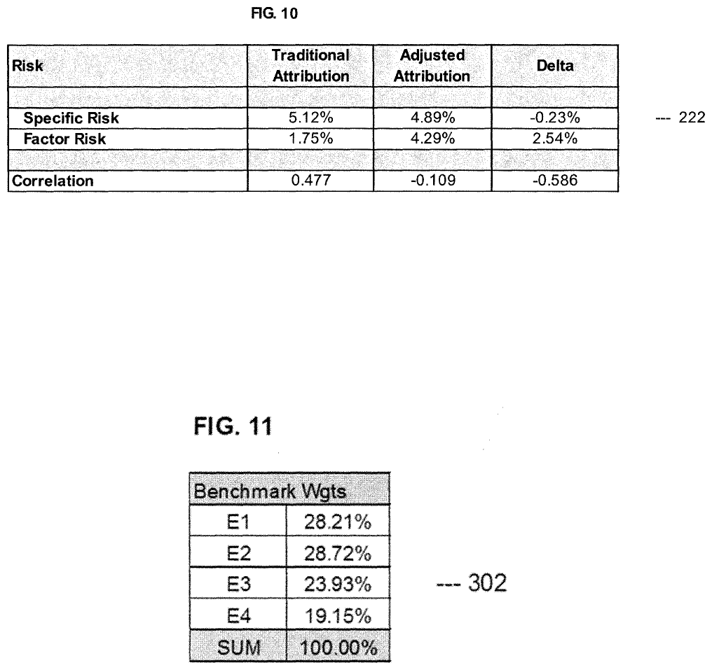

For simplicity, assume that the benchmark weights w_{b} for this universe of assets are the same at all five time periods and given by table 302 in FIG. 11. The sum of the weights is 100%, indicating that the benchmark is fully invested. In practice, the weights of the benchmark vary over time depending on the returns of each asset. In this example, it is assumed that the benchmark is rebalanced at the beginning of each time period so that the relative weights of each asset is the same at all time periods.

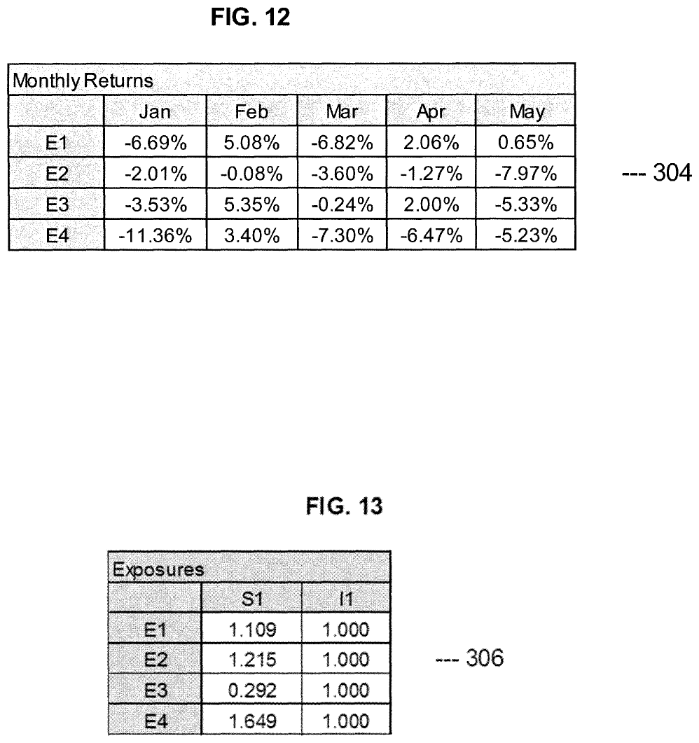

The monthly asset returns r₍ⱼ₎^{(p)}, for the i-th asset in time period p is shown by table 304 in FIG. 12.

Once again for simplicity, only two factor exposures are utilized, e.g., K=2, and it is assumed that the exposures of each asset at each time period are constant. The first factor, denoted as S1, is a style factor, with different exposures for all of the assets. The second factor, denoted as I1, is an industry factor. The exposure of each asset to factor I1 is one. Table 306 in FIG. 13 shows the 4 by 2 exposure matrix, B, for this particular example.

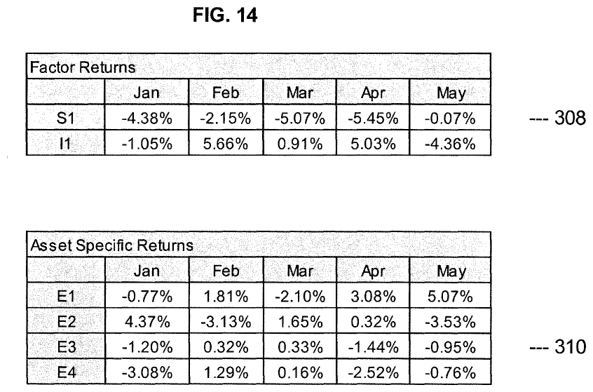

The factor returns for both factors at each time period are determined using ordinary, weighted, least squares, with weights proportional to the square root of the benchmark weights. Table 308 in FIG. 14 shows the factor returns, f₍ⱼ₎^{(p)}, obtained for each factor and time period. Table 310 in FIG. 14 also shows the asset specific returns, ε₍ᵢ₎^{(p)}, for each asset and time period.

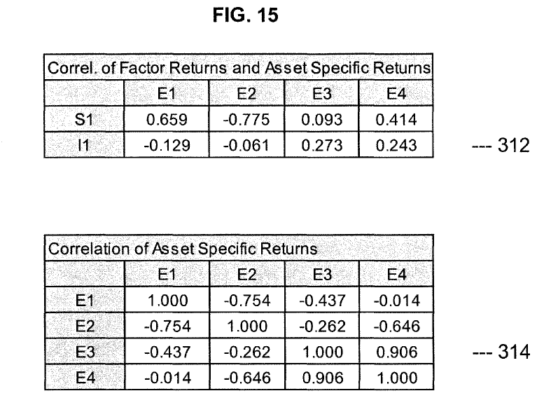

With this data fixed, it can be examined how well some of the assumptions used in factor modelling are satisfied for this extremely simple example. For simplicity, any linking of returns is omitted, although that could easily have been included. Table 312 in FIG. 15 shows the correlations of each of the factor returns to each of the four specific returns. For these correlations, each of the five time periods is equally weighted. Although the minimum and maximum correlations among these different correlations are relatively large (−0.775 and +0.659 respectively), the average correlation is 0.090. So, on average, the assumption that the factor and specific returns are uncorrelated is true.

Table 314 in FIG. 15 shows the correlations among all of the asset specific returns. Again, although the correlations have relatively large minimum and maximum values (−0.754 and 0.906, respectively), the average correlation of specific returns is −0.201, which is reasonably small.

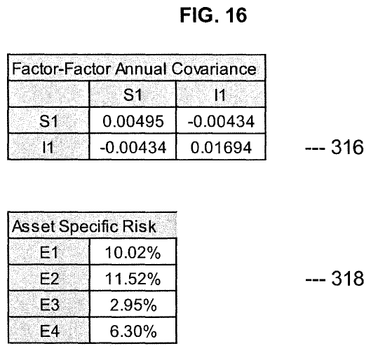

With the assumption of equal weights for each time period, the factor-factor covariances, Σ, and the specific risk (square root of the specific variances=(Δ²)^{1/2}) can be computed. These two items complete the definition of a factor risk model. The factor-factor covariance is shown by table 316 in FIG. 16 while the specific risk is shown by table 318 in FIG. 16. However, the factor risk model for predicted risk is not needed for the present invention.

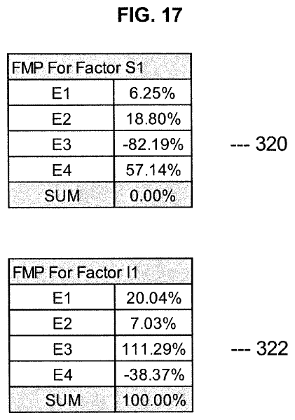

In FIG. 17, table 320 shows the factor-mimicking portfolio associated with factor 51 using the square root of market cap as weights computed using equation (25). This portfolio is long-short dollar neutral in that the sum of the factor-mimicking portfolio weights is zero.

In FIG. 17, table 322 shows the factor-mimicking portfolio associated with factor I1.

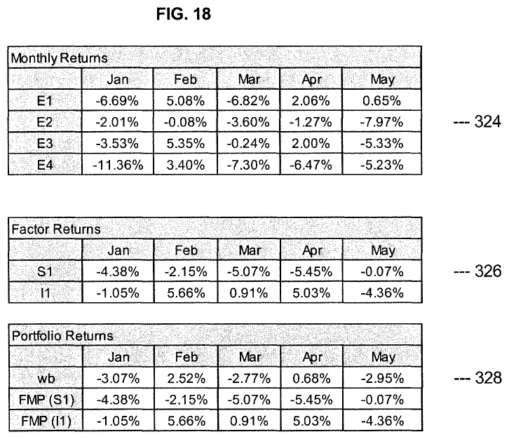

In FIG. 18, table 324 shows the asset returns over time (this table is identical to 304), table 326 shows the factor returns over time (this table is identical to 308), and table 328 shows the returns of the benchmark, the factor-mimicking portfolio associated with S1 and the factor-mimicking portfolio associated with I1. It is evident that the returns of the factor-mimicking portfolio associated with S1 exactly match the factor returns for S1, while the returns of the factor mimicking portfolio associated with I1 exactly match the factor returns for I1.

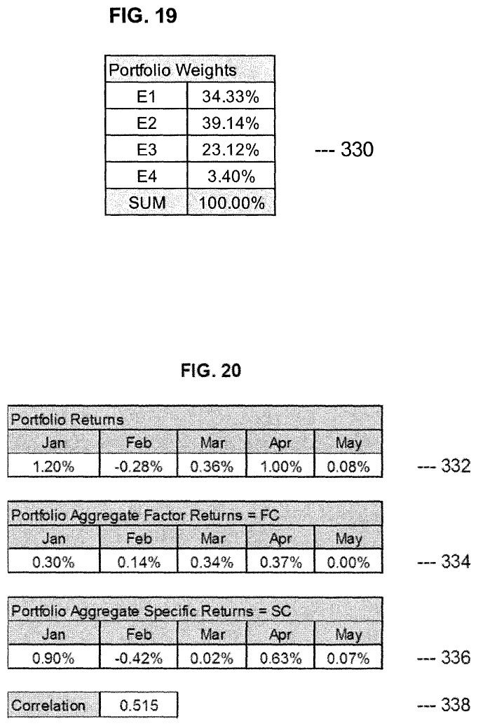

With this background detail of this simple numerical example completed, the performance attribution without linking for two exemplary portfolios is considered. Table 330 in FIG. 19 shows the first exemplary portfolio, with allocations of 34.33%, 39.14%, 23.12%, and 3.40% to each of the four assets respectively. In FIG. 20, four tables are presented. Table 332 shows the returns of the exemplary portfolio for the five time periods. Table 334 shows the aggregate factor returns, FC^{(p)}, for the exemplary portfolio. Table 336 shows the aggregate specific returns, SC^{(p)}, for the exemplary portfolio.

For this exemplary portfolio, the correlation of the time series of factor returns 334 and the time series of specific returns 336 is 0.515, as illustrated in table 338. This is a relatively large, positive correlation between the factor and specific returns, which represents the problem the present invention aims to solve.

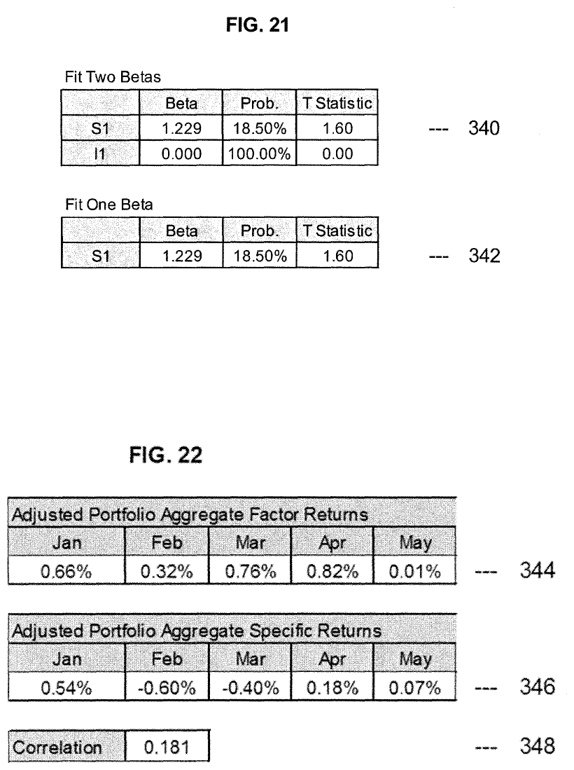

In FIG. 21, table 340 shows the results of a regression to find two betas for the exemplary portfolio, as described in equation (35). The results show a non-zero beta for S1, with a modest level of significance (a p-value of 18.50%, and a T-statistic of 1.60), and an identically zero beta of I1, with no significance whatsoever (a p-value of 100%, and a T-statistic of 0.00). For this particular, extremely simple example, the beta for I1 is identically zero because the sum of the active weights and the exposures for I1 are identically zero and they therefore do not contribute to the regression. This is an artifact of the extreme simplicity of this example. In more realistic cases, the betas for the industry and other factor may be statistically significant.

The results of a second regression using only the S1 factor are shown in table 342. This result represents the reduced set of factors for which the invention is applied in this particular example.

After applying the reduced factor regression results shown in table 342, an adjusted performance attribution shown in FIG. 22 is obtained. Table 344 shows the adjusted aggregate factor returns. Table 346 shows the adjusted aggregate specific returns. The correlation between the of the time series of adjusted factor returns, 344, and the adjusted time series of specific returns, 346, is 0.181, as illustrated in table 348.

This reduction in the correlation of factor and specific returns from 0.515 in table 338 to 0.181 in table 348 represents a substantial improvement in the attribution in that the factor returns are much less correlated with the specific returns.

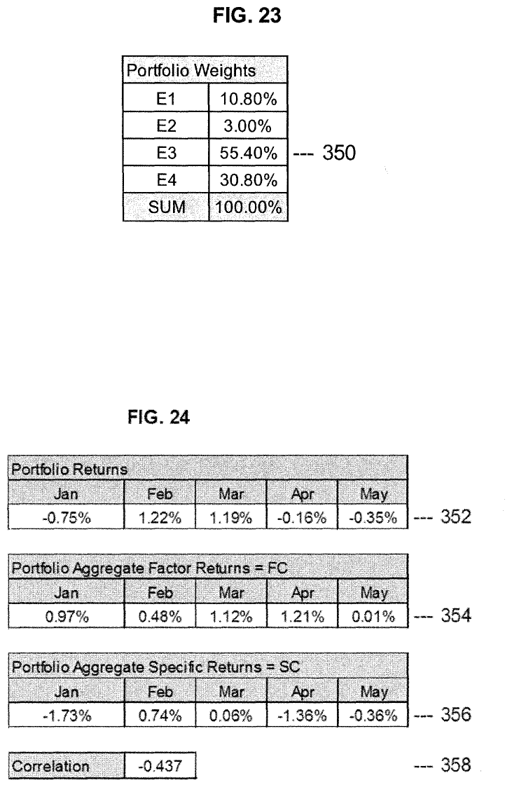

Table 350 in FIG. 23 shows a second exemplary portfolio, with allocations of 10.80%, 3.00%, 55.40%, and 30.80% to each of the four assets respectively. In FIG. 24, table 352 shows the returns of the exemplary portfolio for the five time periods. Table 354 shows the aggregate factor returns, FC^{(p)}, for the exemplary portfolio. Table 356 shows the aggregate specific returns, SC^{(p)}, for the exemplary portfolio.

For this exemplary portfolio, the correlation of the time series of factor returns 354 and the time series of specific returns 356 is −0.437, as illustrated in table 358. This correlation is a relatively large, negative correlation between the factor and specific returns, which represents the problem the present invention aims to solve.

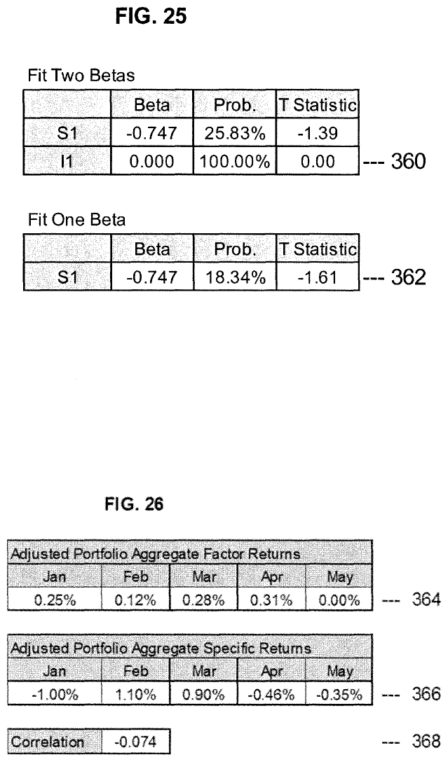

In FIG. 25, table 360 shows the results of a regression to find two betas for the exemplary portfolio, as described in equation (35). The results show a non-zero beta for S1, with a modest level of significance (a p-value of 25.83%, and a T-statistic of −1.39), and an identically zero beta of I1, with no significance whatsoever (a p-value of 100%, and a T-statistic of 0.00).

Results for a second regression using only the S1 factor are shown in table 362. This result represents the reduced set of factors for which the invention is applied in this particular example.

After applying the reduced factor regression results shown in table 362, an adjusted performance attribution shown in FIG. 26 is obtained. Table 364 shows the adjusted aggregate factor returns. Table 366 shows the adjusted aggregate specific returns. The correlation between the of the time series of adjusted factor returns, 364, and the adjusted time series of specific returns, 366, is −0.074, as illustrated in table 368.

This reduction in the correlation of factor and specific returns from −0.437 in table 358 to −0.074 in table 368 represents a substantial improvement in the attribution in that the factor returns are much less correlated with the specific returns.

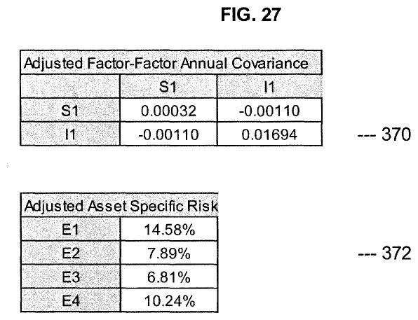

For this second exemplary portfolio, the adjusted factor-factor covariance described in equation (38) and the adjusted specific risk described in equation (39) are shown in FIG. 27 in tables 370 and 372 respectively. For the second exemplary portfolio, the original tracking error predicted by 316 and 318 is 12.11% annual volatility. The adjusted factor risk model predicts a tracking error of 13.34% annual volatility. However, although useful, the original and adjusted factor risk models are not needed to apply the present invention.

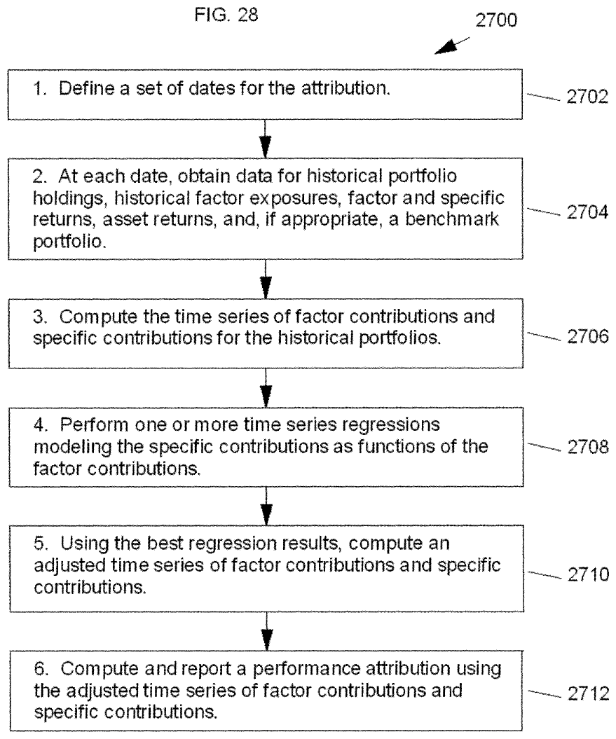

FIG. 28 shows a flow diagram illustrating the steps of process 2700 embodying the present invention. In step 2702, a set of dates is defined over which the performance attribution will be performed. In the simple numerical example presented, these were the five months Jan, Feb, Mar, Apr, and May. In step 2704, at each date, data is obtained including the historical portfolio holdings, historical factor exposures, factor and specific returns, asset returns, and, if appropriate, a benchmark portfolio. In the simple numerical example, these data elements are defined by 302 (the benchmark portfolio), 304 (asset returns), 306 (factor exposures), 308 and 310 (the factor and specific returns), and 330 or 350 (the historical portfolio holdings). In some cases, the factor and specific returns may already be defined. In other cases, the factor and specific returns may need to be computed using the portfolio, exposure, and asset returns data. In step 2706, the time series of factor contributions and specific contributions for the historical portfolios is computed. In the simple numerical example, these are given by 334 (factor contributions) and 336 (specific contributions) for portfolio 330 and 354 (factor contributions) and 356 (specific contributions) for portfolio 350.

In step 2708, one or more time series regressions are computed modelling the specific contributions as functions of the factor contributions, as shown in equation (35). In the simple numerical example, these are given by results 340 (modelling with two degrees of freedom) and 342 (modelling with one degree of freedom) for portfolio 330 and 360 (modelling with two degrees of freedom) and 362 (modelling with one degree of freedom) for portfolio 350. In step 2710, an adjusted time series of factor contributions and specific contribution is computed using the best regression results of step 2708. In the simple numerical example, these are given by 344 (factor contributions) and 346 (specific contribution) for portfolio 330 and 364 (factor contributions) and 366 (specific contribution) for portfolio 350.

Finally, in step 2712, a performance attribution is computed and reported using the adjusted time series of factor and specific contributions. In the simple numerical example, the adjusted factor contributions and specific contributions 344, 346, 364, and 366 represent the essential quantitative data required to present a performance attribution report. More realistic performance attribution reports are exemplified by tables 208, 218, 220, and 222. Litterman describes a wide range of different performance attribution reports that can be constructed using the adjusted factor contributions and specific contributions. These reports can include adjusted factor and specific risk contributions. The contributions may include linking. Axioma sells commercial tools for constructing factor-based and returns-based performance attribution of historical portfolios.

While the present invention has been disclosed in the context of various aspects of presently preferred embodiments, it will be recognized that the invention may be suitable applied to other environments consistent with the claims which follow.

We claim:

1. An improved computer-implemented method for performing calculations not practically calculated by the human mind that are required in rapidly computing and reporting the performance attribution of a set of portfolio holdings over time and providing tools for display of results facilitating appreciation of factor contribution, specific contributions and an adjusted attribution comprising:
electronically receiving and storing by a programmed computer a set of dates defining an attribution time horizon to be analyzed;
for each date, electronically receiving and storing by the programmed computer a historical portfolio of holdings having investment weights in a set of investible assets;
for each date, electronically receiving and storing by the programmed computer a set of factors and a set of factor exposures for each investible asset in the historical portfolio of holdings as of that date;
for each date, electronically receiving and storing or calculating and storing by the programmed computer a factor return for each factor exposure as of that date;
for each date, electronically receiving and storing or calculating and storing by the programmed computer specific returns for all investible assets in the portfolio as of that date;
for each date, computing factor contributions by combining the investment weights of the historical portfolio, the factor exposures and the factor returns as of that date;
for each date, computing specific contributions by combining the investment weights of the historical portfolio and the specific returns as of that date;
computing one or more mathematical models using time series regression that describes a relationship between a time series of specific contributions as a function of the time series of factor contributions;
tabulating a breakdown of a total contribution into a table comprising factor contribution and a specific contribution for each of a traditional attribution and an adjusted attribution to facilitate selection of a preferred mathematical model;
selecting the preferred mathematical model from those computed;
computing an adjusted set of factor contributions and specific contributions utilizing the preferred mathematical model to produce a realized correlation between the factor contributions and the specific contributions closer to zero;
computing a performance attribution for the historical portfolios of holdings based on the adjusted set of factor and specific contributions; and
electronically outputting the performance attribution results using an output device.

2. The method of claim 1 in which the time series regression model is a linear function of a set of factor contributions.

3. The method of claim 2 in which a sequence of mathematical time series regression models is constructed that removes statistically insignificant factor contributions from the model at each iteration of the sequence.

4. The method of claim 1 in which an adjusted factor risk estimate is computed.

5. The method of claim 1 in which the factor exposures, factor returns, and specific returns are derived from a factor risk model.

6. The method of claim 1 in which the table further comprises a style contribution and individual factor contribution for a plurality of factors for the traditional attribution and the adjusted attribution.

7. An improved computer-implemented system for performing calculations not practically calculated by the human mind that are required in rapidly computing and reporting the performance attribution of a set of portfolio holdings over time comprising:
a memory storing data for a set of dates defining an attribution time horizon to be performed;
a processor executing software to retrieve data for historical portfolios of holdings having investment weights in a set of investible assets at each date;
said processor operating to retrieve data for a set of factors and a set of factor exposures for each investible asset in the historical portfolio of holdings as of that date;
said processor operating to retrieve data or compute data for a factor return for each factor exposure as of that date;
said processor operating to retrieve data or compute data for a specific return for all investible assets in the portfolio as of that date;
said processor computing the factor contributions for each factor by combining the investment weights of the historical portfolios, the factor exposures, and the factor returns for each date;
said processor computing the specific contributions by combining the investment weights of the historical portfolios and the specific returns for each date;
said processor computing one or more mathematical models using time series regression that describes a relationship between a time series of specific contributions as a function of the time series of factor contributions;
tabulating a breakdown of a total contribution into a table comprising a factor contribution and a specific contribution for each of a traditional attribution and an adjusted attribution to facilitate selection of a preferred mathematical model;
selecting the preferred mathematical model from those computed;
said processor computing an adjusted set of factor contributions and specific contributions utilizing the preferred mathematical model for each date to produce a realized correlation between the factor contributions and the specific contributions closer to zero;
said processor computing a performance attribution for the historical portfolios of holdings based on the adjusted set of factor and specific contributions; and
an output device electronically outputting the performance attribution results.

8. The system of claim 7 in which the time series regression model is a linear function of a set of factor contributions.

9. The system of claim 8 in which a sequence of mathematical time series regression models is constructed that removes statistically insignificant factor contributions from the model at each iteration of the sequence.

10. The system of claim 7 in which an adjusted factor risk estimate is computed.

11. The system of claim 7 in which the factor exposures, factor returns, and specific returns are derived from a factor risk model.

12. The system of claim 11 in which a modified factor risk model is estimated using the adjusted factor and specific returns.

13. An improved computer-implemented method for performing calculations not practically calculated by the human mind that are required in rapidly computing and reporting factor and specific contributions for a set of portfolio holdings over time comprising:
electronically receiving and storing by a programmed computer a set of dates defining a time horizon for the computation;
for each date, electronically receiving and storing by the programmed computer a historical portfolio of holdings having investment weights in a set of investible assets;
for each date, electronically receiving and storing by the programmed computer a factor risk model comprising a set of factors, a set of factor exposures for each investible asset in the historical portfolio of holdings, factor returns for each factor, and specific returns for each investible asset in the historical portfolio of holdings as of that date;
for each date, computing a first set of factor contributions by combining the investment weights of the historical portfolios, the factor exposures, and the factor returns as of that date;
for each date, computing a first set of specific contributions by combining the investment weights of the historical portfolios and the specific returns of the assets in the historical portfolio as of that date;
computing one or more mathematical models using time series regression that describes a relationship between a time series of specific contributions as a function of the time series of factor contributions;
tabulating a breakdown of a total contribution into a table comprising factor contribution and a specific contribution for each of a traditional attribution and an adjusted attribution to facilitate selection of a preferred mathematical model
selecting a preferred mathematical model from those computed;
computing an adjusted set of factor contributions and specific contributions utilizing the preferred mathematical model to produce a realized correlation between the factor contributions and the specific contributions closer to zero; and
electronically outputting the adjusted set of factor and specific contributions using an output device.

14. The method of claim 13 in which the time series regression model is a linear function of a set of factor contributions.

15. The method of claim 14 in which a sequence of mathematical time series regression models is constructed that identifies the most statistically significant factor contributions from the model at each iteration of the sequence.

16. The method of claim 15 in which the adjusted factor and specific contributions are used to produce a performance attribution for the historical portfolios.

17. The method of claim 16 in which an adjusted factor risk estimate is computed.

18. The method of claim 15 in which a modified factor risk model is estimated using the adjusted factor and specific contributions.

19. A computer-implemented system for computing and reporting factor and specific contributions for a set of portfolio holdings over time comprising:
a memory storing data for a set of dates defining an attribution time horizon to be performed;
a processor executing software to retrieve data for a historical portfolio of holdings having investment weights in a set of investible assets at each date;
said processor operating to retrieve data for a factor risk model comprising a set of factors, a set of factor exposures for every asset in the historical portfolio, factor returns for every factor, and asset specific returns for every asset in the historical portfolio of holdings as of that date;
said processor computing factor contributions by combining the investment weights of the historical portfolio, the factor exposures, and the factor returns as of that date;
said processor computing specific contributions by combining the weights of the historical portfolio and the specific returns as of that date;
said processor computing on the processor one or more mathematical models using time series regression that describes a relationship between a time series of specific contributions as a function of the time series of factor contributions;
tabulating a breakdown of a total contribution into a factor contribution and a specific contribution for each of a traditional attribution and an adjusted attribution to facilitate selection of a preferred mathematical model;
selecting the preferred mathematical model from those computed;
said processor computing an adjusted set of factor contributions and specific contributions utilizing the preferred mathematical model for each date to produce a realized correlation between the factor contributions and the specific contributions closer to zero;
an output device electronically outputting the adjusted factor and specific contributions.

20. The system of claim 19 in which the time series regression model is a linear function of a set of factor contributions.
